(19) United States
(12) Patent Application Publication
(10) Pub. No.: US 2026/0285063 A1
(43) Pub. Date: Sep. 24, 2026

(54) MEDIUM CONVEYING APPARATUS AND RECORDING APPARATUS

(71) Applicant: SEIKO EPSON CORPORATION, Tokyo (JP)

(72) Inventors: Nobuyuki NISHI, HARA- MURA (JP); Masashi OGAWA, SHIOJIRI-SHI (JP); Shinya KAWABATA, SHIOJIRI-SHI (JP); Yayoi YOSHIMURA, MATSUMOTO-SHI (JP)

(21) Appl. No.: 19/569,084

(22) Filed: Mar. 17, 2026

(30) Foreign Application Priority Data
Mar. 19, 2025 (JP) 2025-044581

(51) Int. Cl. B41J 11/00; H04N 1/00

(52) U.S. Cl. CPC B41J 11/007; H04N 1/00615

(57) ABSTRACT

A medium conveying apparatus includes: a placement portion on which a medium is to be placed in an inclined posture, the placement portion being displaceable between a feeding position at which the medium is fed and a standby position before starting the feeding of the medium; a feeding portion configured to feed the medium from the placement portion in a feeding direction; a conveying portion provided downstream of the feeding portion in the feeding direction and configured to convey the medium; and a reversing unit provided to be attachable to and detachable from an apparatus main body and including, below the placement portion, a reversing portion that curves and reverses the medium, in which the placement portion is provided in the reversing unit, and a region downstream of the placement portion in the feeding direction is exposed by detaching the reversing unit from the apparatus main body.

The present application is based on, and claims priority from JP Application Serial Number 2025-044581, filed Mar. 19, 2025, the disclosure of which is hereby incorporated by reference herein in its entirety.

### BACKGROUND

### 1. Technical Field

The present disclosure relates to a medium conveying apparatus that conveys a medium, and a recording apparatus.

### 2. Related Art

In a recording apparatus disclosed in JP-A-2018-134854, a medium reversing unit is attachably and detachably provided on a back surface of an apparatus main body. The medium reversing unit includes a reversing roller, and when the medium reversing unit is detached from the apparatus main body, a region on a back surface side of a medium support portion that supports a medium in an inclined posture is open, and jam processing can be performed. Note that, in the present specification, the jam processing means removing a medium jammed in the apparatus.

JP-A-2018-134854 is an example of the related art.

In the recording apparatus disclosed in JP-A-2018-134854, when the medium reversing unit is detached from the apparatus main body, the region on the back surface side of the medium support portion is open, and thus, when a jam occurs around the reversing roller, the jam processing is easily performed, but when a jam occurs at a position further back than the medium support portion, there is a problem that it is difficult to perform a jam processing operation.

### SUMMARY

In order to solve the above problems, a medium conveying apparatus according to an aspect of the present disclosure includes: a placement portion on which a medium is to be placed in an inclined posture, the placement portion being displaceable between a feeding position at which the medium is fed and a standby position before starting the feeding of the medium; a feeding portion configured to feed the medium from the placement portion in a feeding direction; a conveying portion provided downstream of the feeding portion in the feeding direction and configured to convey the medium; and a reversing unit provided to be attachable to and detachable from an apparatus main body and including, below the placement portion, a reversing portion that curves and reverses the medium, in which the placement portion is provided in the reversing unit, and a region downstream of the placement portion in the feeding direction is exposed by detaching the reversing unit from the apparatus main body.

In addition, a recording apparatus according to another aspect of the present disclosure includes: the above medium conveying apparatus; and a recording unit configured to perform recording on the medium conveyed by the medium conveying apparatus.

### BRIEF DESCRIPTION OF THE DRAWINGS

FIG. 1 is a diagram illustrating a feeding path and a conveying path of a printer.

FIG. 2 is an external perspective view of the printer.

FIG. 3 is an external perspective view of the printer in a state where a medium support portion is falling and developed.

FIG. 4 is an external perspective view of the printer in a state where a reversing unit has been detached.

FIG. 5A is a side sectional view of the reversing unit and surroundings thereof, illustrating a state where a placement portion is at a standby position.

FIG. 5B is a side sectional view of the reversing unit and surroundings thereof, illustrating a state where the placement portion is at a feeding position.

FIG. 6A is a side sectional view of the reversing unit and surroundings thereof, illustrating a state where the reversing unit has been attached.

FIG. 6B is a side sectional view of the reversing unit and surroundings thereof, illustrating a process of detaching the reversing unit.

FIG. 7 is a perspective view of the reversing unit.

FIG. 8 illustrates perspective views of a separation roller, illustrating opening and closing of a cover.

FIG. 9 illustrates views illustrating a relationship between the reversing unit and a guide member, illustrating a transition of attachment and detachment of the reversing unit.

FIG. 10 is a view of a first path forming portion and a second path forming portion viewed from a width direction.

FIG. 11 is a perspective view of a cam member.

FIG. 12 illustrates top views of a locking member, illustrating an operation transition of the locking member.

FIG. 13A illustrates side views of the reversing unit, the cam member, and the guide member, illustrating displacement of the placement portion.

FIG. 13B illustrates side views of the reversing unit, the cam member, and the guide member, illustrating a state transition when detaching the reversing unit.

FIG. 13C illustrates side views of the reversing unit, the cam member, and the guide member, illustrating a state transition when detaching the reversing unit.

### DESCRIPTION OF EMBODIMENTS

Hereinafter, the present disclosure will be schematically described.

A medium conveying apparatus according to a first aspect includes: a placement portion on which a medium is to be placed in an inclined posture, the placement portion being displaceable between a feeding position at which the medium is fed and a standby position before starting the feeding of the medium; a feeding portion configured to feed the medium from the placement portion in a feeding direction; a conveying portion provided downstream of the feeding portion in the feeding direction and configured to convey the medium; and a reversing unit provided to be attachable to and detachable from an apparatus main body and including, below the placement portion, a reversing portion that curves and reverses the medium, in which the placement portion is provided in the reversing unit, and a region downstream of the placement portion in the feeding direction is exposed by detaching the reversing unit from the apparatus main body.

According to this aspect, since the placement portion is provided in the reversing unit, and the region downstream of the placement portion in the feeding direction is exposed by detaching the reversing unit from the apparatus main body, it is possible to easily perform a jam processing operation when a jam occurs in the region downstream of the placement portion.

A second aspect is an aspect according to the first aspect, in which the reversing unit includes a separation portion configured to separate the medium by nipping the medium between the separation portion and the feeding portion, and the separation portion is separated from the feeding portion by detaching the reversing unit.

According to this aspect, since the reversing unit includes the separation portion configured to separate the medium by nipping the medium between the separation portion and the feeding portion, and the separation portion is separated from the feeding portion by detaching the reversing unit, it is possible to easily remove the medium even when a part of the jammed medium is positioned between the feeding portion and the separation portion.

A third aspect is an aspect according to the first aspect, in which the reversing unit includes a locking portion configured to lock the placement portion at the standby position, and the locking portion releases the locking in an attached state of the reversing unit and locks the placement portion at the standby position in a detached state of the reversing unit.

When the placement portion is positioned at the feeding position in the detached state of the reversing unit, there is a concern that a stacked state of media supported by the placement portion is disturbed.

According to this aspect, since the locking portion configured to lock the placement portion at the standby position in the detached state of the reversing unit is provided, it is possible to prevent the stacked state of the media supported by the placement portion from being disturbed in the detached state of the reversing unit.

Note that, this aspect is not necessarily an aspect according to the first aspect, and may be an aspect according to the second aspect.

A fourth aspect is an aspect according to the third aspect, in which the apparatus main body includes a guide portion configured to guide the placement portion from the feeding position to the standby position when detaching the reversing unit from the attached state, and when the reversing unit is detached, the locking portion locks, at the standby position, the placement portion guided from the feeding position to the standby position by the guide portion.

When the reversing unit is detached in a state where the placement portion is positioned at the feeding position, the placement portion cannot be locked at the standby position by the locking portion.

However, according to this aspect, even when the reversing unit is detached in the state where the placement portion is positioned at the feeding position, due to the guide portion, the placement portion can be locked at the standby position by the locking portion.

A fifth aspect is an aspect according to the fourth aspect, in which the placement portion includes an engagement portion that engages with the guide portion, the guide portion has an inclined surface with which the engagement portion comes into contact, and when detaching the reversing unit, the placement portion is guided from the feeding position to the standby position by the inclined surface.

According to this aspect, it is possible to smoothly displace the placement portion from the feeding position to the standby position by the inclined surface.

A sixth aspect is an aspect according to the fifth aspect, in which the inclined surface is a first inclined surface, the guide portion has a second inclined surface with which the engagement portion comes into contact, and when attaching the reversing unit in a state where the placement portion is at the feeding position, the placement portion is guided from the feeding position to the standby position by the second inclined surface.

The placement portion is made at the standby position by the locking portion in the detached state of the reversing unit. However, in the detached state of the reversing unit, the placement portion may be unintentionally displaced from the standby position to the feeding position due to an impact or the like. In this manner, in a case where the placement portion is at the feeding position in the detached state of the reversing unit, when attaching the reversing unit, the medium placed on the placement portion is likely to dash into the apparatus main body.

However, according to this aspect, since the placement portion is displaced from the feeding position to the standby position by the second inclined surface when attaching the reversing unit, it is possible to prevent the above-described problem.

A seventh aspect is an aspect according to the fourth aspect, in which a part of the reversing unit is configured to climb over a part of the apparatus main body when detaching the reversing unit, and the guide portion guides the placement portion to the standby position after the reversing unit is lifted such that the part of the reversing unit climbs over the part of the apparatus main body.

In a case where a part of the reversing unit is configured to climb over a part of the apparatus main body when detaching the reversing unit, a user needs to lift the reversing unit. In this manner, when the user lifts the reversing unit, once the placement portion receives an external force from the guide portion, a large operation force is required for the user, and there is a concern that operability decreases.

According to this aspect, since the guide portion guides the placement portion to the standby position after the reversing unit is lifted such that the part of the reversing unit climbs over the part of the apparatus main body, a large operation force is prevented from being required when detaching the reversing unit.

Note that, this aspect is not necessarily an aspect according to the fourth aspect, and may be an aspect according to the fifth or sixth aspect.

An eighth aspect is an aspect according to the third aspect, in which the locking portion is movable to a locking position at which the placement portion is locked and an unlocking position at which the locking is released by being displaced in an intersecting direction intersecting an attachment and detachment direction of the reversing unit, a pressing portion configured to press the locking portion toward the locking position is provided, a contact member configured to engage with the locking portion is provided at a position facing the locking portion when the reversing unit is attached and detached, in the attached state of the reversing unit, the locking portion is positioned at the unlocking position by coming into contact with the contact member, and in the detached state of the reversing unit, the locking portion is positioned at the locking position by the pressing portion.

According to this aspect, the placement portion can be locked and unlocked with a simple configuration.

Note that, this aspect is not necessarily an aspect according to the third aspect, and may be an aspect according to any one of the fourth to seventh aspects.

A ninth aspect is an aspect according to the third aspect, in which the placement portion is displaced to the standby position and the feeding position by swinging, and is pressed toward the feeding position, the apparatus main body includes a cam that presses down the placement portion from the feeding position to the standby position, and the cam holds the placement portion at the standby position in a state where the locking portion releases the locking.

According to this aspect, since the cam holds the placement portion at the standby position in the state where the locking portion releases the locking, it is possible to prevent the placement portion from moving to the feeding position in the attached state of the reversing unit, and thus it is possible to prevent the medium loaded on the placement portion from dashing downstream in the feeding direction.

Note that, this aspect is not necessarily an aspect according to the third aspect, and may be an aspect according to any one of the fourth to eighth aspects.

A tenth aspect is an aspect according to the first aspect, in which a medium cassette provided vertically below the reversing unit and configured to accommodate the medium before being fed is further provided, the medium fed from the medium cassette is fed to the reversing portion, a feeding path from the medium cassette to the reversing portion is formed by attaching the reversing unit, and at least a part of the feeding path is open by detaching the reversing unit.

According to this aspect, since at least a part of the feeding path is open by detaching the reversing unit, a plurality of paths can be open by detaching the reversing unit, and the jam processing operation becomes easier.

Note that, this aspect is not necessarily an aspect according to the first aspect, and may be an aspect according to any one of the second to ninth aspects.

An eleventh aspect is an aspect according to the seventh aspect, in which a medium cassette provided vertically below the reversing unit and configured to accommodate the medium before being fed is further provided, the medium fed from the medium cassette is fed to the reversing portion, a feeding path from the medium cassette to the reversing portion is formed by attaching the reversing unit, at least a part of the feeding path is open by detaching the reversing unit, the reversing unit includes a first path forming portion where the feeding path is formed, the apparatus main body includes a second path forming portion where the feeding path is formed, in the attached state of the reversing unit, the first path forming portion and the second path forming portion overlap each other when viewed from a width direction intersecting the feeding direction of the medium, a wall portion is provided in a direction of detaching the reversing unit with respect to the first path forming portion, and when detaching the reversing unit, the first path forming portion, which is a part of the reversing unit, climbs over the wall portion, which is a part of the apparatus main body.

According to this aspect, since at least a part of the feeding path is open by detaching the reversing unit, a plurality of paths can be open by detaching the reversing unit, and the jam processing operation becomes easier.

In addition, since the first path forming portion and the second path forming portion overlap each other when viewed from the width direction intersecting the feeding direction of the medium in the attached state of the reversing unit, it is possible to smoothly guide the medium compared to a configuration in which a gap is formed between the first path forming portion and the second path forming portion.

In addition, since the wall portion is provided in the direction of detaching the reversing unit with respect to the first path forming portion, it is possible to prevent a gap from being formed in an appearance of the apparatus and to prevent dust or the like from entering the apparatus.

Since, when detaching the reversing unit, the first path forming portion, which is a part of the reversing unit, is configured to climb over the wall portion, which is a part of the apparatus main body, the user needs to lift the reversing unit when detaching the reversing unit. At this time, since the guide portion starts guiding the placement portion from the feeding position to the standby position after the first path forming portion climbs over the wall portion, a large operation force is prevented from being required when detaching the reversing unit.

A recording apparatus according to a twelfth aspect includes: the medium conveying apparatus according to any one of the first to eleventh aspects; and a recording unit configured to perform recording on the medium conveyed by the medium conveying apparatus.

According to this aspect, in the recording apparatus, the operation and effects of any one of the first to eleventh aspects can be obtained.

Hereinafter, the present disclosure will be specifically described.

Hereinafter, an inkjet printer 1 is described as an example of a recording apparatus that performs recording on a medium. The inkjet printer 1 is hereinafter simply referred to as a printer 1. Note that, the printer 1 can also be referred to as a medium conveying apparatus 100 from the viewpoint of conveying the medium. In this case, the printer 1 can be referred to as a recording apparatus including the medium conveying apparatus 100 and a line head 30 to be described later.

Note that, an X-Y-Z coordinate system illustrated in the drawings is an orthogonal coordinate system, in which arrow directions are positive (+) directions, and opposite directions to the positive directions are negative (-) directions. An X-axis direction is an apparatus width direction and is a width direction intersecting a direction of conveying the medium on which recording is performed. When viewed from an operator of the printer 1, a +X direction is a left side and a -X direction is a right side. Hereinafter, the X-axis direction is sometimes referred to as a medium width direction or simply referred to as a width direction.

A Y-axis direction is an apparatus depth direction and is a direction along a medium conveying direction during recording. A +Y direction is a direction from a back surface toward a front surface of the apparatus and a -Y direction is a direction from the front surface toward the back surface of the apparatus. In the embodiment, among side surfaces constituting a periphery of the printer 1, a side surface in the +Y direction is an apparatus front surface and a side surface in the -Y direction is an apparatus back surface.

A Z-axis direction is a direction along a vertical direction and is an apparatus height direction. A +Z direction is a vertically upward direction, and a -Z direction is a vertically downward direction.

Note that, hereinafter, a direction in which a medium is conveyed is sometimes referred to as "downstream" and a direction opposite to the direction is sometimes referred as "upstream".

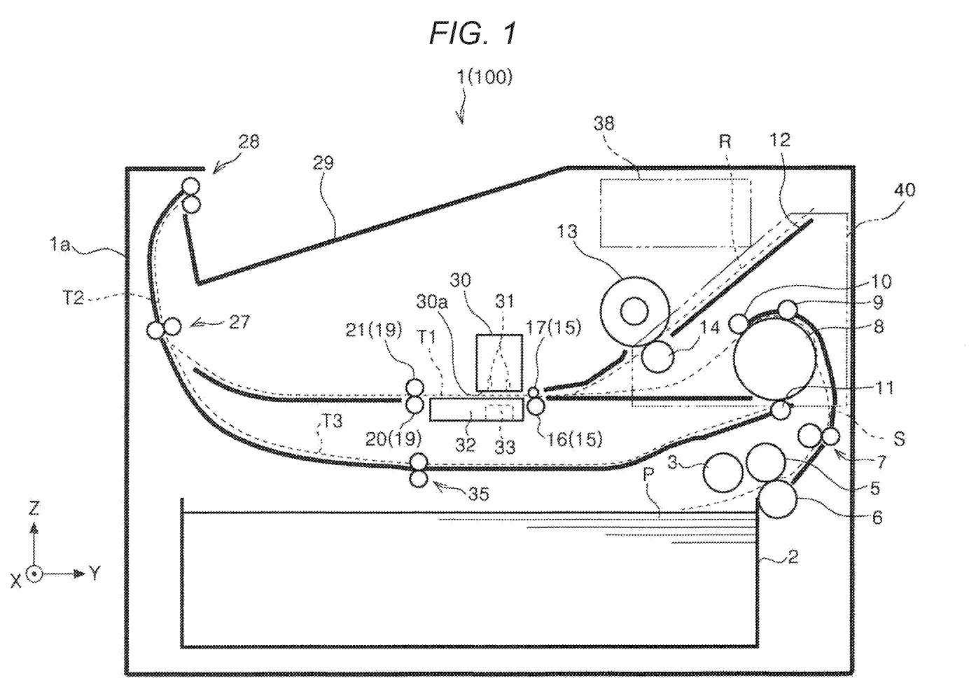

Hereinafter, a feeding path and a conveying path of the printer 1 will be described with reference to FIG. 1. In FIG. 1, the feeding path and the conveying path are indicated by broken lines.

Reference sign S denotes a feeding path along which a medium is fed from a medium cassette 2, and in the embodiment, is a path from the medium cassette 2 to a first conveying roller pair 15 via a reversing roller 8.

Reference sign R denotes a feeding path along which the medium is fed from a placement portion 12, and in the embodiment, is a path from the placement portion 12 to the first conveying roller pair 15 via a feeding roller 13.

Reference sign T1 denotes a first conveying path which faces the line head 30, which is an example of a liquid ejection head, and along which the medium is conveyed. In the embodiment, the first conveying path T1 is a path from the first conveying roller pair 15 to a second conveying roller pair 19.

Reference sign T2 denotes a second conveying path which is coupled to the first conveying path T1 to curve the medium upward and reverse the medium after the line head 30 performs recording on the medium. In the embodiment, the second conveying path T2 is a path from the second conveying roller pair 19 to a discharge roller pair 28.

Reference sign T3 denotes a third conveying path which is positioned below the first conveying path T1, which receives the medium reversely fed along the second conveying path T2, and which guides the medium to the feeding path S. In the embodiment, the third conveying path T3 is a path from a third conveying roller pair 27 to be described later to the feeding path S via a fourth conveying roller pair 35.

The first conveying path T1, the second conveying path T2, the third conveying path T3, and the line head 30 are provided inside an apparatus main body 1a. A part of the feeding path S, a part of the feeding path R, and a part of the third conveying path T3 are formed by a reversing unit 40 that is attachable to and detachable from the apparatus main body 1a. When the reversing unit 40 is attached, the above-described paths are formed. The reversing unit 40 will be described in detail later.

Hereinafter, a configuration on the paths will be described in order from the feeding path S.

Reference sign P denotes media stored in the medium cassette 2. An example of the media is recording paper. The medium cassette 2 is attachable to and detachable from the apparatus main body 1a of the printer 1 from the apparatus front surface.

A pickup roller 3 driven by a motor (not illustrated) is provided above the medium cassette 2. The pickup roller 3 is capable of advancing to and retracting from the media stored in the medium cassette 2 and rotates while being in contact with the media stored in the medium cassette 2 to feed the media from the medium cassette 2 in the +Y direction.

A feeding roller 5 driven by a motor (not illustrated) and a separation roller 6, to which a rotational torque is applied by a torque limiter (not illustrated), are provided downstream of the medium cassette 2. The media fed from the medium cassette 2 are separated by being nipped by the feeding roller 5 and the separation roller 6, are sent to a feeding roller pair 7, and are further sent downstream.

The reversing roller 8 driven by a motor (not illustrated) is provided downstream of the feeding roller pair 7. A first nip roller 9, a second nip roller 10, and a third nip roller 11 are provided around the reversing roller 8. The medium fed along the feeding path S is nipped by the reversing roller 8 and the first nip roller 9, and is further nipped by the reversing roller 8 and the second nip roller 10 and conveyed. The direction of conveying the medium is reversed from the +Y direction to the -Y direction by the reversing roller 8, and the medium is conveyed downstream.

The reversing roller 8 is an example of a reversing portion that curves and reverses the medium. The reversing roller 8 is provided below the placement portion 12 to be described later. The reversing roller 8 and the placement portion 12 together constitute the reversing unit 40.

The printer 1 includes the feeding path R for feeding the medium from the placement portion 12 in addition to the feeding path S for feeding the medium from the medium cassette 2. The placement portion 12 supports the medium in an inclined posture, and the supported medium is conveyed to the first conveying roller pair 15 by the feeding roller 13 driven by a motor (not illustrated). Reference sign 14 denotes a separation roller to which a rotational torque is applied by a torque limiter (not illustrated). The feeding roller 13 is an example of a feeding portion that feeds the medium from the placement portion 12 in a feeding direction, and the separation roller 14 is an example of a separation portion that separates the media by nipping the media between the separation roller 14 and the feeding roller 13.

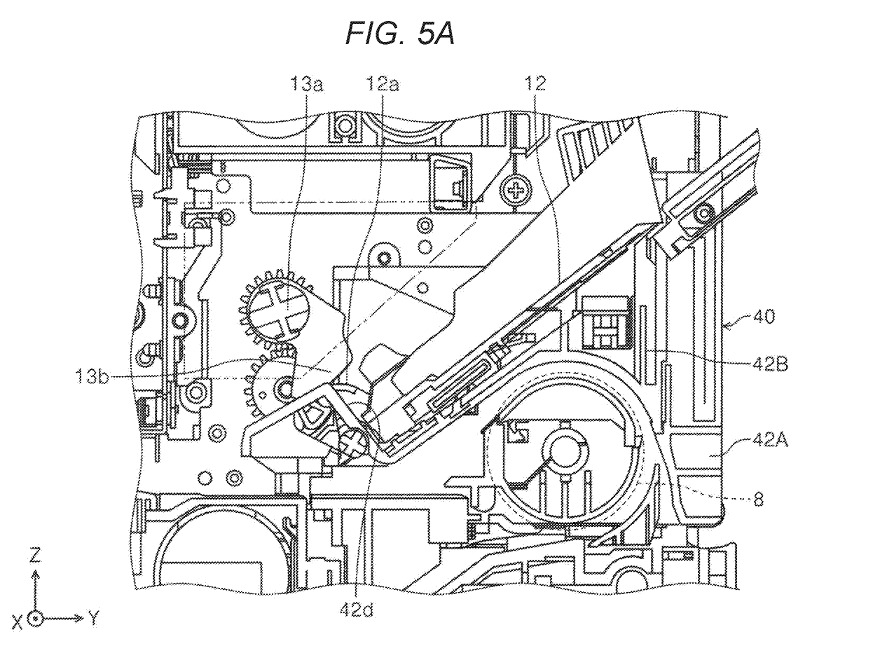

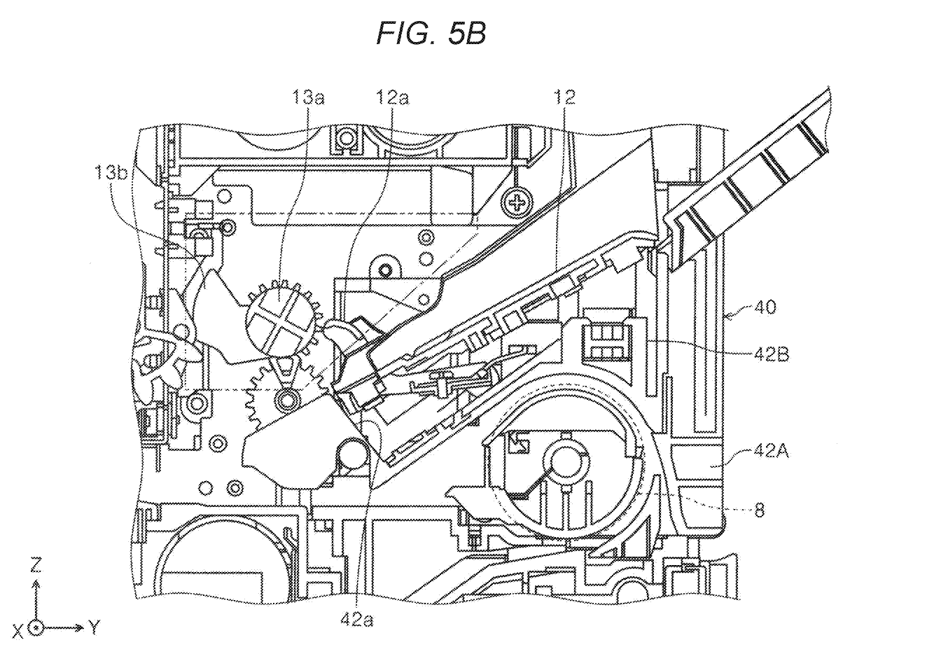

The placement portion 12 can swing around a swing shaft (not illustrated), and can be displaced between a feeding position at which the placed medium can be fed by the feeding roller 13 by swinging and a standby position before starting feeding of the medium. FIG. 5A illustrates a state where the placement portion 12 is at the standby position, and FIG. 5B illustrates a state where the placement portion 12 is at the feeding position. Reference sign 13a denotes a rotation shaft of the feeding roller 13, and the rotation shaft 13a is provided with a cam 13b. The placement portion 12 is provided with a cam follower portion 12a engageable with the cam 13b. The cam 13b and the cam follower portion 12aare positioned outside a medium placement region in the width direction.

The placement portion 12 is pressed toward the feeding position by a pressing member (not illustrated), for example, a coil spring, and at the standby position illustrated in FIG. 5A, the cam 13b presses down the cam follower portion 12a, that is, the placement portion 12, against a pressing force of the pressing member. When the feeding is started from this state and the rotation shaft 13a rotates, the cam follower portion 12a, that is, the placement portion 12, is released from being pressed down by the cam 13b as illustrated in FIG. 5B, and the placement portion 12 moves to the feeding position. When the rotation shaft 13afurther rotates from this state, the cam 13b again presses down the cam follower portion 12a, that is, the placement portion 12, against the pressing force of the pressing member as illustrated in FIG. 5A, and the placement portion 12 moves from the feeding position to the standby position.

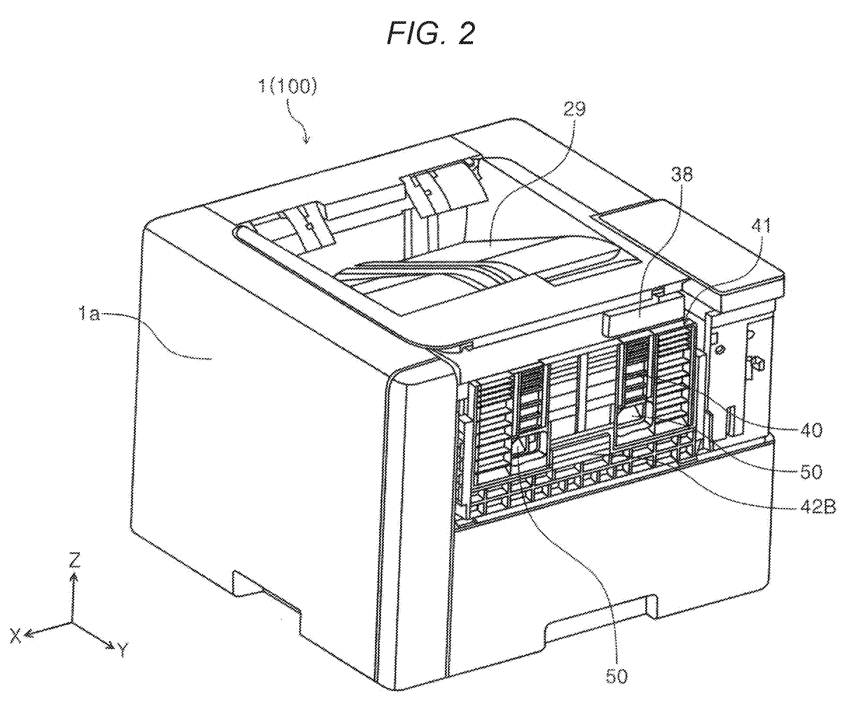

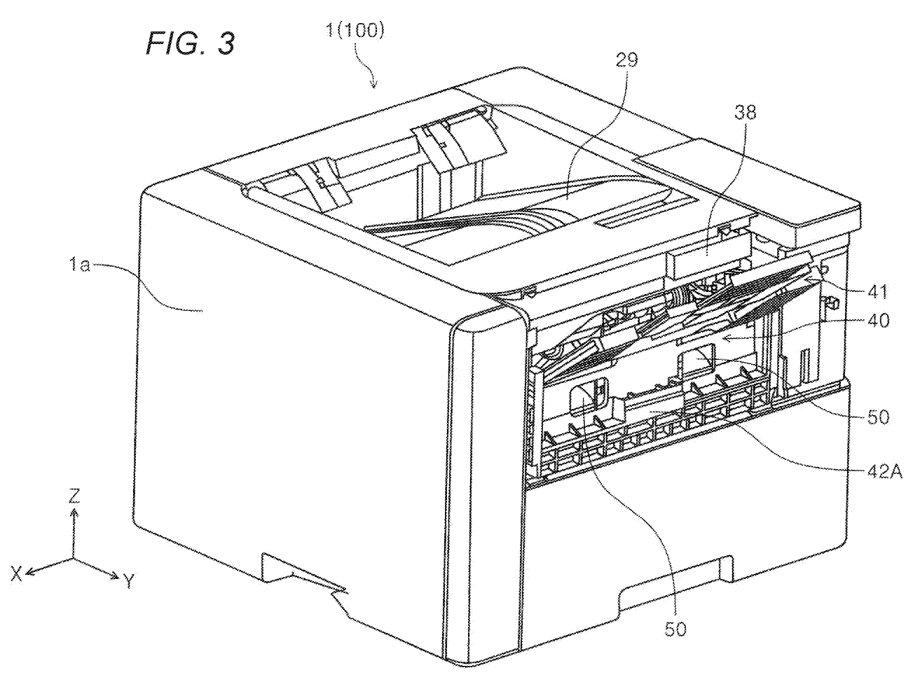

Returning to FIG. 1, a functional unit 38 is provided above the placement portion 12 (see also FIGS. 2 and 3). The functional unit 38 is a unit having a predetermined function, and is, for example, a pump unit that sucks a liquid from a cap portion 33 to be described later. However, the functional unit 38 is not limited thereto, and may be a unit having another function such as a power supply unit or a control unit.

Since the functional unit 38 is provided, an upper space of the placement portion 12 is narrowed, and a region downstream of the feeding roller 13 is less likely to be accessed by a user. However, by detaching the reversing unit 40 to be described later, a region downstream of the feeding roller 13 can be accessed.

The first conveying roller pair 15 including a drive roller 16, which is driven by a motor (not illustrated), and a driven roller 17, which is rotatable when driven, are provided downstream of the reversing roller 8. The driven roller 17 is pressed toward the drive roller 16 by a pressing member (not illustrated). The first conveying roller pair 15 is an example of a conveying portion that is provided downstream of the feeding roller 13 in the feeding direction and that conveys the medium.

The line head 30 is an example of a recording unit that performs recording on a medium, and is an example of a liquid ejection head that performs recording by ejecting an ink, which is an example of a liquid, onto a medium. The line head 30 is a liquid ejection head in which a plurality of nozzles 31, for ejecting the ink, are arranged to cover the entire medium in the medium width direction. The line head 30 is formed as a liquid ejection head elongated in the medium width direction, and capable of performing recording on the entire medium width region without moving in the medium width direction.

Reference sign 30a denotes a head surface facing the medium. The head surface 30amay also be referred to as a liquid ejection surface or a nozzle surface. The head surface 30a is parallel to the medium conveying direction, that is, the Y-axis direction, at a position facing the line head 30. The head surface 30ais parallel to an X-Y plane.

The printer 1 includes an ink storage (not illustrated), and the ink ejected from the line head 30 is supplied from the ink storage to the line head 30 via an ink tube (not illustrated).

Note that, instead of the line head 30, a recording head that performs recording on the medium while moving along the medium width direction may be adopted. In addition, the device for performing recording on the medium is not limited to a system which performs printing on the medium by ejecting the ink and may be formed with a recording head of other systems such as a dot impact system.

A facing portion 32 is provided at a position facing the head surface 30a of the line head 30. The facing portion may also be referred to as platen. The facing portion 32 according to the embodiment includes an openable and closable shutter (not illustrated). The facing portion 32 supports the medium in a state where the shutter is closed. Hereinafter, a gap between the facing portion 32 and the head surface 30a is referred to as a platen gap.

The cap portion 33 is provided below the shutter (not illustrated). When the shutter opens, the cap portion 33 and the head surface 30a can face each other. The line head 30 is provided to be capable of rising and lowering with power from a motor (not illustrated). The cap portion 33 can cover the head surface 30a when the line head 30 is lowered in a state where the shutter is open.

A movement region of the line head 30 includes, in addition to a recording position and a cap position where the cap portion 33 covers the head surface 30a, a jam processing position where the line head 30 is at the highest position. When the line head 30 is raised to the jam processing position, the platen gap is the largest. Accordingly, when a jam occurs, the jammed medium can be removed.

The second conveying roller pair 19 including a drive roller 20, which is driven by a motor (not illustrated), and a driven roller 21, which is rotatable when driven, are provided downstream of the line head 30. The medium that has been subjected to recording is sent downstream by the second conveying roller pair 19.

The driven roller 21 is supported by a second unit 42. The drive roller 20 is an example of a first roller, and the driven roller 21 is an example of a second roller positioned above the drive roller 20.

The third conveying roller pair 27 is provided downstream of the second conveying roller pair 19, and further the discharge roller pair 28 is provided downstream of the third conveying roller pair 27. The medium that has been subjected to recording is discharged to a discharge tray 29 by the discharge roller pair 28 in a state where the most recent recording surface faces down.

In the case of performing recording on both surfaces of the medium, the medium is fed to the third conveying path T3 by the third conveying roller pair 27 and the discharge roller pair 28 rotating reversely. The fourth conveying roller pair 35 is provided in the third conveying path T3, and the medium fed to the third conveying path T3 is fed between the reversing roller 8 and the third nip roller 11 by the fourth conveying roller pair 35. Then, the medium enters the feeding path S and is sent toward the first conveying roller pair 15 again by the reversing roller 8. By providing such the third conveying path T3, recording can be performed on both surfaces of the medium.

Next, the reversing unit 40 will be described.

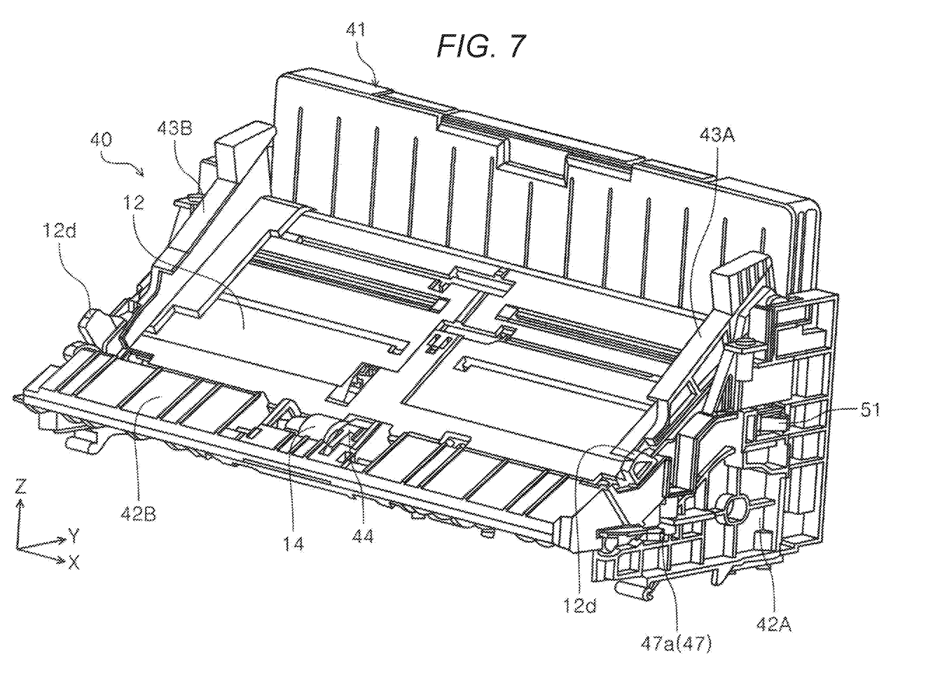

As illustrated in FIG. 7, in the reversing unit 40, a base body includes a first base portion 42A and a second base portion 42B, and members constituting the reversing unit 40 are provided in these base portions.

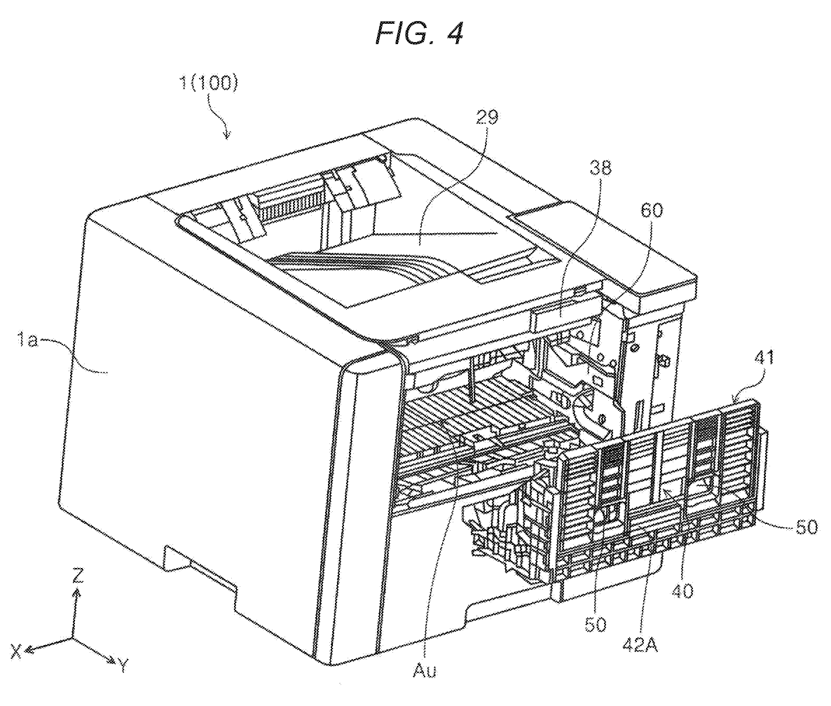

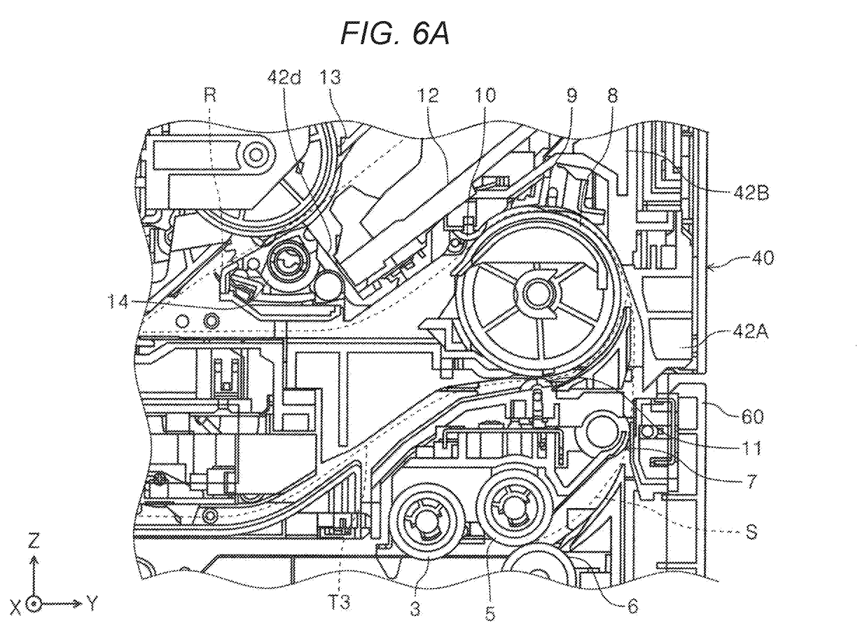

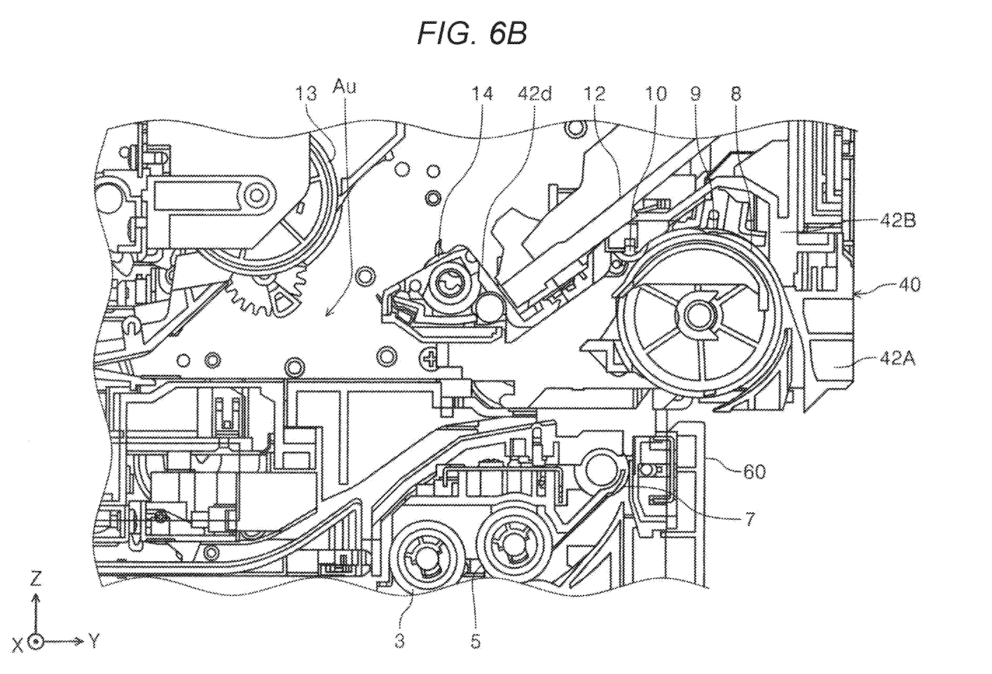

As illustrated in a change from FIGS. 2 - 4 and as illustrated in a change from FIGS. 6A - 6B the reversing unit 40 is attachably and detachably provided from a front surface side of the apparatus main body 1a. When the reversing unit 40 is detached, an internal region Au is open as illustrated in FIGS. 4 and 6B, and a jam processing operation can be performed. When the reversing unit 40 is detached in the embodiment, at least a part of each of the feeding path S, the feeding path R, and the third conveying path T3 described with reference to FIG. 1 is open, and the medium jammed in each path can be removed. In particular, in the embodiment, when the reversing unit 40 is detached, substantially the entire feeding path R is open.

As illustrated in FIGS. 2 to 4, the reversing unit 40 includes a pair of unlocking operation units 50 on the front surface side. In addition, locking portions 51 (see FIG. 7) are provided on both side surfaces of the reversing unit 40. The locking portion 51 can protrude from the side surface of the reversing unit 40, and an attached state of the reversing unit 40 is locked by locking the locking portion 51 to a lock portion (not illustrated) of the apparatus main body 1a in the attached state of the reversing unit 40. When the pair of unlocking operation units 50 are operated to approach each other, the locking portion 51 enters a non-protruding state, the locking is released, and the reversing unit 40 can be detached.

The reversing unit 40 includes a medium support portion 41 on the front surface side. The medium support portion 41 can be switched between a vertical posture along the apparatus front surface as illustrated in FIG. 2 and an inclined posture falling forward of the apparatus as illustrated in FIG. 3, and can be switched between a developed state as illustrated in FIG. 3 and a stored state as illustrated in FIG. 2. The medium support portion 41 supports the medium in an inclined posture together with the placement portion 12 (see FIG. 1) by being in the inclined posture and the developed state as illustrated in FIG. 2.

The reversing unit 40 includes edge guides 43A and 43B as illustrated in FIG. 7. The edge guides 43A and 43B are provided to be slidable in the X-axis direction, that is, the width direction, in the placement portion 12, and are provided to approach to or separate from each other by a rack and pinion mechanism (not illustrated). The edge guides 43A and 43B guide edges in the width direction of the medium placed on the placement portion 12.

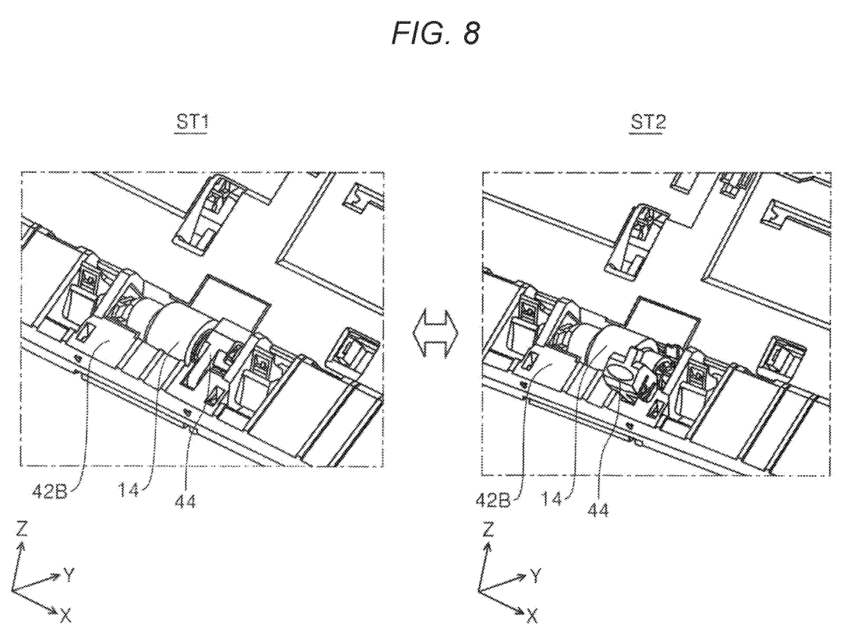

As illustrated in FIG. 7, the reversing unit 40 includes the separation roller 14 at a center of the second base portion 42B in the X-axis direction, that is, the width direction. A cover 44 is rotatably provided at a position adjacent to the separation roller 14 as illustrated in FIG. 8, and the separation roller 14 is locked as illustrated in a state ST1 in FIG. 8 in a state where the cover 44 is closed. As illustrated in a state ST2 in FIG. 8, when the cover 44 is open, the separation roller 14 can be detached and replaced. Note that, the apparatus main body 1a may be provided with a portion that comes into contact with the cover 44 to close the cover 44 when the reversing unit 40 is attached with the cover 44 open.

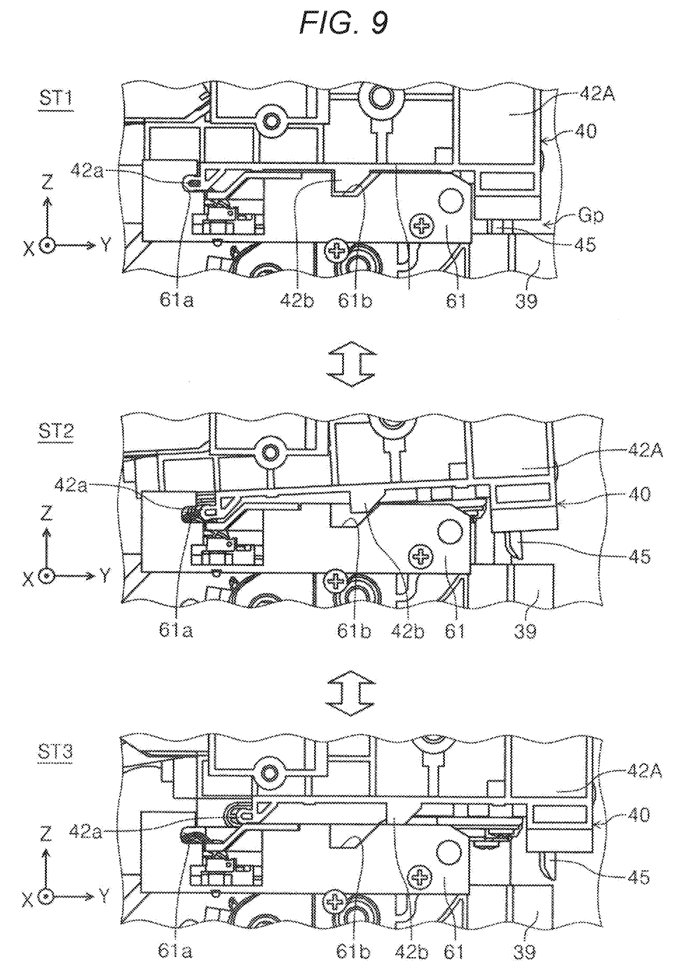

As illustrated in FIG. 9, a guide member 61 is provided in the apparatus main body 1a to which the reversing unit 40 is attached.

The guide member 61 has a first recess 61a and a second recess 61b. The first base portion 42A of the reversing unit 40 is provided with a first protrusion 42a and a second protrusion 42b. The first protrusion 42a can be fitted into the first recess 61a, and the second protrusion 42b can be fitted into the second recess 61b. A position of the reversing unit 40 in the attached state is determined by fitting each protrusion into each recess, and particularly, an insertion limit position of the reversing unit 40 during attachment is defined.

Note that, the first recess 61a, the second recess 61b, the first protrusion 42a, and the second protrusion 42b are provided on both sides of a medium conveying region in the width direction.

The state ST1 in FIG. 9 is the attached state of the reversing unit 40. When detaching the reversing unit 40 from this state, the +Y direction, that is, the front surface side of the reversing unit 40 is slightly lifted as illustrated in the state ST2 in a state where the unlocking operation units 50 described with reference to FIGS. 2 to 4 are operated. Accordingly, when the second protrusion 42bis removed from the second recess 61b and then the reversing unit 40 is pulled out, the first protrusion 42a is removed from the first recess 61a as illustrated in a state ST3. Accordingly, the reversing unit 40 is placed on an upper portion of the guide member 61 without being caught, and can be pulled out straight in the +Y direction, that is, forward.

Note that, in the case of attaching the reversing unit 40, the above operation is reversed, and the state transitions in the order of the state ST3, the state ST2, and the state ST1.

In this manner, the user is guided to lift the front surface side of the reversing unit 40 when detaching the reversing unit 40. This is to prevent a first path forming portion 45 to be described later from being caught on a main body frame 39.

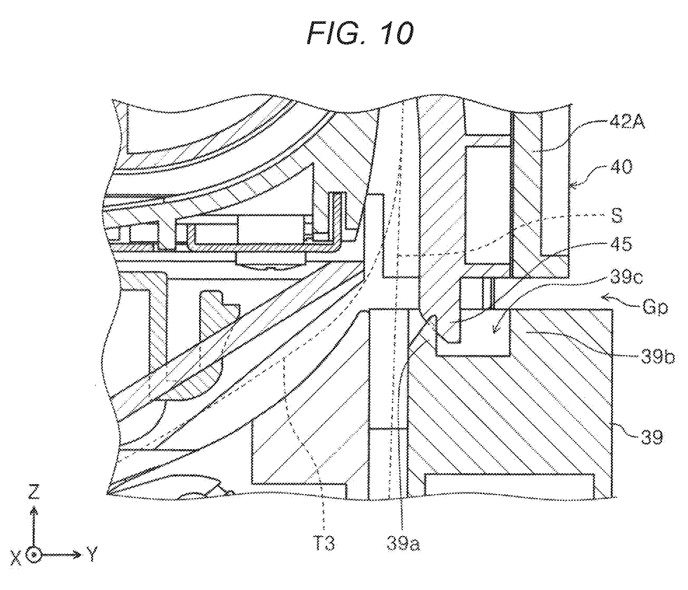

More specifically, as illustrated in FIG. 10, the reversing unit 40 includes the first path forming portion 45, and a second path forming portion 39a is formed in the main body frame 39 constituting the apparatus main body 1a. FIG. 10 illustrates a boundary portion between the reversing unit 40 and the apparatus main body 1a on the apparatus front surface in the attached state of the reversing unit 40. The first path forming portion 45 and the second path forming portion 39a form a part of the feeding path S.

As illustrated in the drawing, in the attached state of the reversing unit 40, the first path forming portion 45 and the second path forming portion 39a are configured to overlap each other when viewed from the X-axis direction, that is, the width direction intersecting the feeding direction of the medium. A plurality of first path forming portions 45 and a plurality of second path forming portions 39a are provided at predetermined intervals along the width direction, and are both provided in a comb shape so as not to interfere with each other when attaching the reversing unit 40 and so as to overlap when viewed from the width direction.

The first path forming portion 45 enters a recess 39c formed in the main body frame 39, and in this state, a wall portion 39b is provided in the +Y direction, that is, in a direction of detaching the reversing unit 40, with respect to the first path forming portion 45. The wall portion 39b functions to reduce a gap Gp at the boundary portion between the reversing unit 40 and the apparatus main body 1a, thereby improving the appearance of exterior and preventing dust or the like from entering the apparatus.

However, when such the wall portion 39b is provided, there is a concern that the first path forming portion 45 collides with the wall portion 39b and is damaged when detaching the reversing unit 40. Therefore, in order to prevent this, the user is guided to lift the front surface side of the reversing unit 40 when detaching the reversing unit 40.

Accordingly, when detaching the reversing unit 40, the first path forming portion 45, which is a part of the reversing unit 40, can climb over the wall portion 39b, which is a part of the apparatus main body 1a.

As described above, since the first path forming portion 45 and the second path forming portion 39a overlap each other when viewed from the width direction in the attached state of the reversing unit 40, it is possible to smoothly guide the medium in the feeding path S and to particularly prevent the medium from being caught, compared to a configuration in which a gap is formed between the first path forming portion 45 and the second path forming portion 39a.

Next, a locking portion capable of locking the placement portion 12 at the standby position will be described.

As illustrated in FIG. 7, a contact portion 47a, which is a part of a locking member 47, is exposed on the side surface of the reversing unit 40. Note that, although the locking member 47 provided on the side surface of the reversing unit 40 in the +X direction is illustrated in FIG. 7, the locking member 47 is also exposed on the side surface in the -X direction.

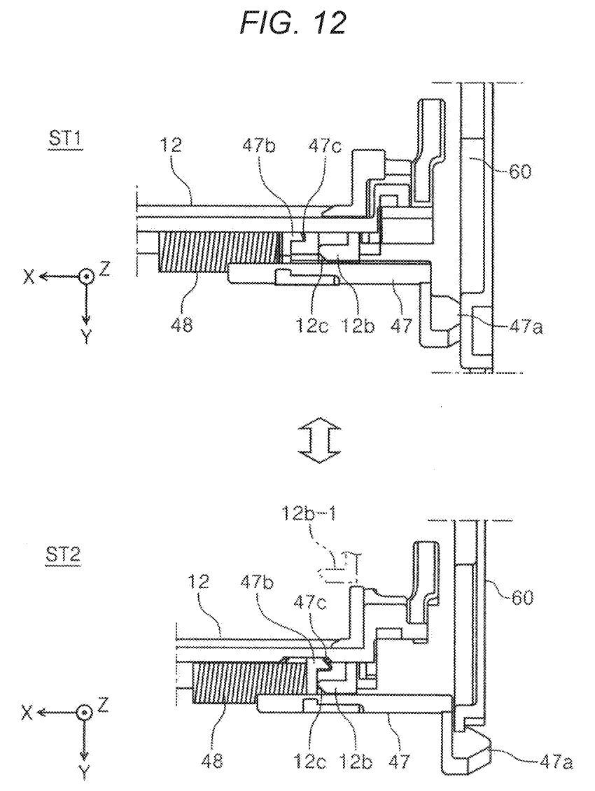

In FIG. 12, the locking member 47 is provided to be slidable along the X-axis direction intersecting the Y-axis direction, which is an attachment and detachment direction of the reversing unit 40, and is pressed in a direction protruding from the side surface of the reversing unit 40 by a coil spring 48, which is an example of a pressing portion.

Note that, although FIG. 12 illustrates the configuration of the locking member 47 provided in the -X direction and the periphery thereof, the configuration of the locking member 47 provided in the +X direction and the periphery thereof is symmetrical to the configuration illustrated in FIG. 12 in the X-axis direction.

The locking member 47 is provided with a hook-shaped locking portion 47b. The placement portion 12 is provided with a hook-shaped locked portion 12b. FIG. 12 illustrates a state where the placement portion 12 is at the standby position. When the locking member 47 slides in a direction protruding from the side surface of the reversing unit 40 in a state where the placement portion 12 is at the standby position, the locked portion 12b can be engaged with the locking portion 47b as illustrated in a state ST2 in FIG. 12. This position is a locking position of the locking member 47.

In FIG. 12, since an upward direction of the placement portion 12 is a displacement direction to the feeding position, when the locked portion 12b can be engaged with the locking portion 47b as illustrated in the state ST2 in FIG. 12, a movement of the placement portion 12 to the feeding position is restricted, and the placement portion 12 is locked at the standby position.

When the locking member 47 slides toward the inside of the reversing unit 40 from this state, the locking portion 47b is separated from the locked portion 12b as illustrated in the state ST1 in FIG. 12, and the placement portion 12 is movable toward the feeding position. That is, the locked state of the placement portion 12 is released. The position of the locking member 47 in this case is an unlocking position.

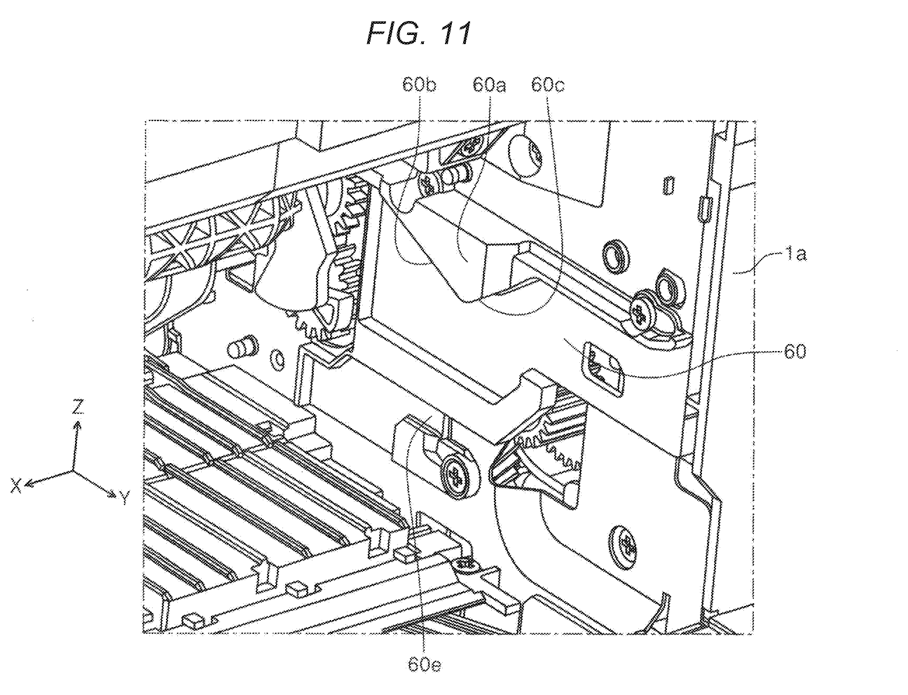

The locking member 47 includes the contact portion 47a at a distal end portion thereof. The contact portion 47a is contactable to a cam member 60 (also FIGS. 4 and 11) provided in the apparatus main body 1a. The cam member 60 is an example of a contact member engageable with the locking member 47. A contact surface of the cam member 60 with which the contact portion 47a comes into contact is a surface indicated by reference sign 60e in FIG. 11.

When attaching the reversing unit 40, by bringing the contact portion 47a into contact with the cam member 60, the locking member 47 slides from the locking position toward the unlocking position as illustrated by a change from the state ST2 to the state ST1 in FIG. 12. When detaching the reversing unit 40, the contact portion 47a releases the contact with the cam member 60, and the locking member 47 slides from the unlocking position toward the locking position as illustrated by a change from the state ST2 to the state ST1 in FIG. 12.

Here, when a paper jam occurs in the middle of paper feeding, the feeding operation may be stopped while the placement portion 12 is positioned at the feeding position. Since a leading end of the medium set on the placement portion 12 is supported by a leading end support surface 42d (see FIGS. 5A and 5B) formed on the second base portion 42B, as illustrated in FIG. 5B, when detaching the reversing unit 40 in a state where the placement portion 12 is at the feeding position, there is a concern that the medium supported on the placement portion 12 falls down from above the placement portion 12. In order to prevent this, the printer 1 includes a guide portion that guides the placement portion 12 from the feeding position to the standby position when detaching the reversing unit 40.

The guide portion is implemented by a first inclined surface 60b provided in the cam member 60 as illustrated in FIGS. 4 and 11. As illustrated in FIG. 11, the cam member 60 has the first inclined surface 60b. The first inclined surface 60bis provided in a cam portion 60ain the -Y direction. Note that, a second inclined surface 60cis formed in the cam portion 60ain the +Y direction, which is to be described later.

As illustrated in FIG. 7, the placement portion 12 is provided with a cam engagement portion 12d. The cam engagement portion 12dis provided at an end portion in the +X direction and an end portion in the -X direction in the placement portion 12 and outside the medium placement region. In addition, the cam engagement portion 12dis provided to protrude upward from the placement portion 12.

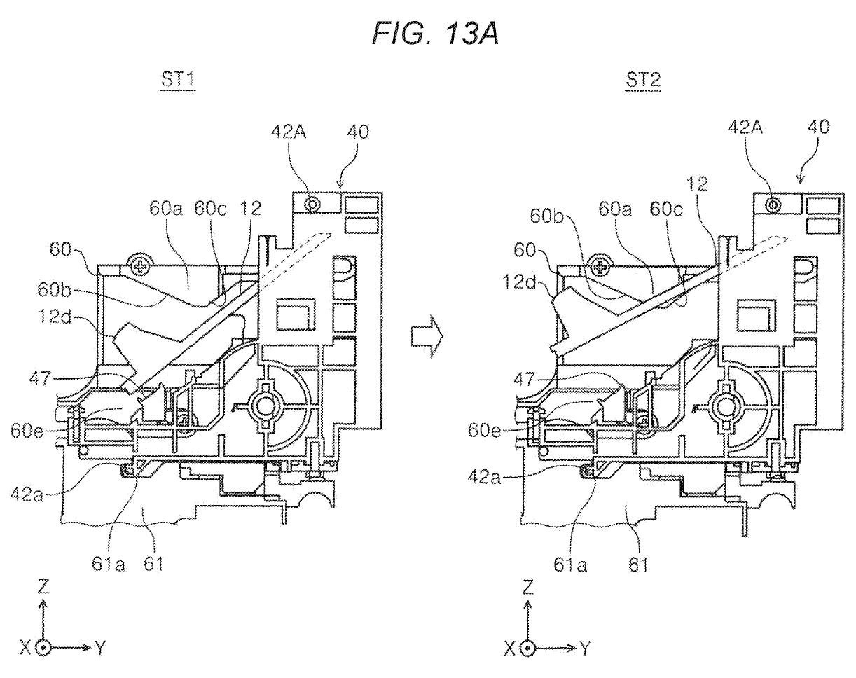

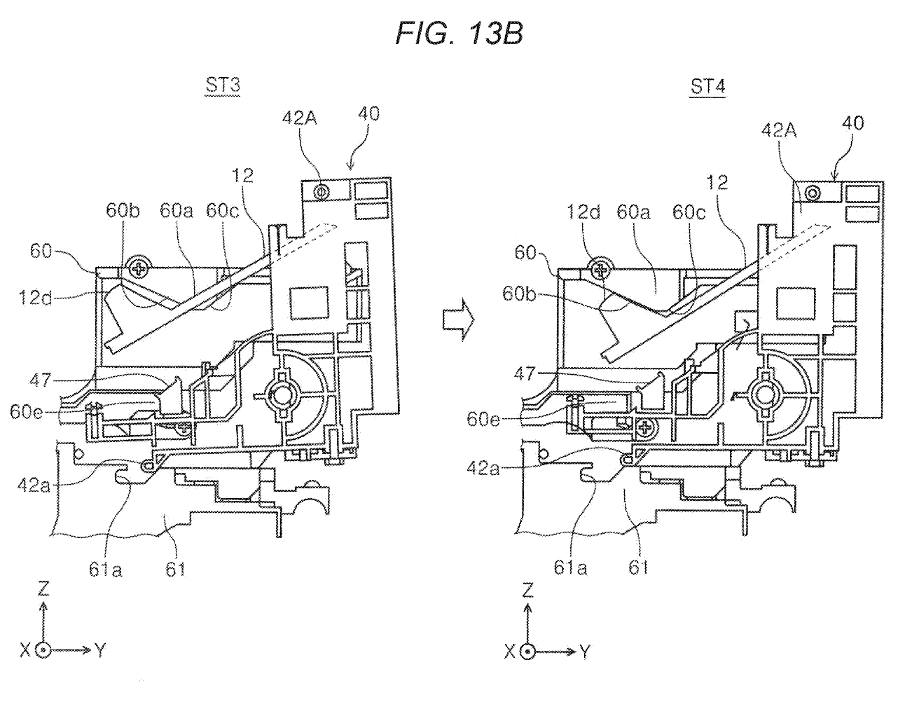

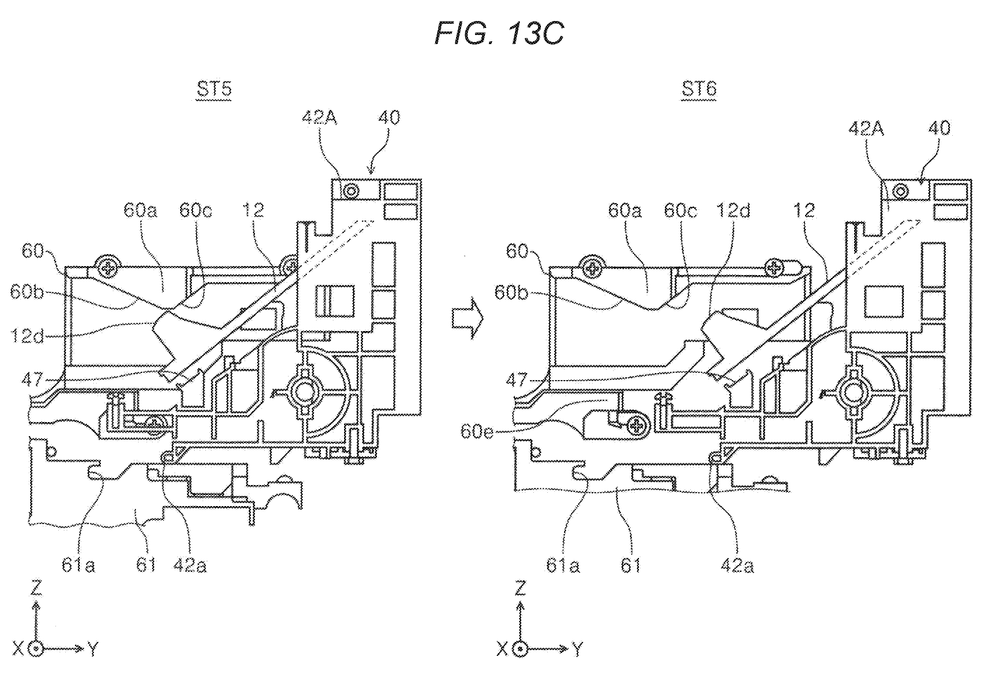

The state ST1 in FIG. 13A illustrates a state where the reversing unit 40 is attached and the placement portion 12 is at the standby position. In this state, the cam engagement portion 12dis positioned below a height position of the first inclined surface 60b. When the feeding is started from this state, the placement portion 12 moves to the feeding position as illustrated in the state ST2 in FIG. 13A, and the cam engagement portion 12d moves to the height position of the first inclined surface 60b along with this.

Note that, the state of the apparatus is depicted as changing in the order of states ST1 and ST2 in FIG. 13A, states ST3 and ST4 in FIG. 13B, and states ST5 and ST6 in FIG. 13C.

When the sheet feeding operation is stopped in the state ST2 in FIG. 13A and the reversing unit 40 is pulled out by the user, the front surface side of the reversing unit 40 is lifted as illustrated in the state ST3 in FIG. 13B, and the reversing unit 40 is pulled out in the +Y direction as illustrated in the state ST4 in FIG. 13B. At this time, the cam engagement portion 12dcomes into contact with the first inclined surface 60b.

Since the first inclined surface 60b is inclined downward in the +Y direction, when the reversing unit 40 is further pulled out in the +Y direction from the state ST4, the cam engagement portion 12d is pressed down by the first inclined surface 60b as illustrated by a change from the state ST4 in FIG. 13B to the state ST5 in FIG. 13C, and accordingly the placement portion 12 moves to the standby position.

Note that, during the movement of the placement portion 12 to the standby position, the locking member 47 described with reference to FIG. 12 moves to the locking position as illustrated in the state ST2 in FIG. 12. Therefore, the locked portion 12b provided in the placement portion 12 is removed from the locking portion 47b as indicated by reference sign 12b-1 in the state ST2 in FIG. 12.

However, the locking portion 47b is formed with a slope 47c, and the locked portion 12b is also formed with a slope 12c. Therefore, even in a state where the locked portion 12b is removed from the locking portion 47b, the locked portion 12b can press away the locking portion 47b and move to a position locked by the locking portion 47b, and the locked portion 12b can be locked by the locking portion 47b.

Note that, when an impact or the like is applied to the reversing unit 40 in the detached state of the reversing unit 40, the locking is released, and the placement portion 12 may move from the standby position to the feeding position. In this case, the cam engagement portion 12dcomes into contact with the second inclined surface 60c provided on the cam portion 60a, and the placement portion 12 is returned from the feeding position to the standby position by the second inclined surface 60c. At this time, similarly to the above, the locked portion 12b can be moved from the position where the locked portion 12b is removed from the locking portion 47b to the position where the locked portion 12b is locked by the locking portion 47b.

Hereinafter, the operation and effect of the printer 1 or the medium conveying apparatus 100 having the above-described configuration will be described.

First, the placement portion 12 is provided in the reversing unit 40, and a region downstream of the placement portion 12 in the feeding direction is exposed by detaching the reversing unit 40 from the apparatus main body 1a. This region is included in the internal region Au illustrated in FIGS. 4 and 6B.

Accordingly, when a jam occurs in the region downstream of the placement portion 12, the jam processing operation can be easily performed.

In addition, the reversing unit 40 includes the separation roller 14 that separates the media by nipping the media between the separation roller 14 and the feeding roller 13. Then, when the reversing unit 40 is detached, the separation roller 14 is separated from the feeding roller 13 as illustrated in the change from FIGS. 6A - 6B. With such a configuration, even when a part of the jammed medium is positioned between the feeding roller 13 and the separation roller 14, the medium can be easily removed.

Next, the reversing unit 40 includes the locking member 47 capable of locking the placement portion 12 at the standby position. The locking member 47 releases the locking in the attached state of the reversing unit 40 and locks the placement portion 12 at the standby position in the detached state of the reversing unit 40.

When the placement portion 12 is positioned at the feeding position in the detached state of the reversing unit 40, there is a concern that a stacked state of the media supported by the placement portion 12 is disturbed, but since the placement portion 12 is locked at the standby position in the detached state of the reversing unit 40, it is possible to prevent the stacked state of the media supported by the placement portion 12 from being disturbed in the detached state of the reversing unit 40.

In addition, the apparatus main body 1a has the first inclined surface 60b as the guide portion that guides the placement portion 12 from the feeding position to the standby position when detaching the reversing unit 40 from the attached state. Then, when the reversing unit 40 is detached, the locking member 47 locks, at the standby position, the placement portion 12 guided from the feeding position to the standby position by the first inclined surface 60b. In this manner, even when the reversing unit 40 is detached in the state where the placement portion 12 is positioned at the feeding position, the placement portion 12 is guided from the feeding position to the standby position, and the placement portion 12 can be locked at the standby position by the locking member 47.

The placement portion 12 includes the cam engagement portion 12d that engages with the first inclined surface 60b. Then, when detaching the reversing unit 40, the placement portion 12 is guided from the feeding position to the standby position by the first inclined surface 60b.

According to such a configuration, it is possible to smoothly displace the placement portion 12 displaced from the feeding position to the standby position by the first inclined surface 60b.

In addition, the cam member 60 has the second inclined surface 60c with which the cam engagement portion 12d comes into contact. When attaching the reversing unit 40 in a state where the placement portion 12 is at the feeding position, the placement portion 12 is guided from the feeding position to the standby position by the second inclined surface 60c.

The placement portion 12 is made at the standby position by the locking member 47 in the detached state of the reversing unit 40. However, in the detached state of the reversing unit 40, the placement portion 12 may be unintentionally displaced from the standby position to the feeding position due to an impact or the like. In this manner, in a case where the placement portion 12 is at the feeding position in the detached state of the reversing unit 40, when attaching the reversing unit 40, the medium placed on the placement portion 12 is likely to dash into the apparatus main body 1a. In addition, when the placement portion 12 is at the feeding position in attaching the reversing unit 40, the feeding operation cannot be started immediately after the reversing unit 40 is attached.

However, according to the embodiment, since the placement portion 12 is displaced from the feeding position to the standby position by the second inclined surface 60c when attaching the reversing unit 40, it is possible to prevent the above-described problem.

Next, when detaching the reversing unit 40, as described with reference to FIG. 10, the first path forming portion 45, which is a part of the reversing unit 40, is configured to climb over the wall portion 39b, which is a part of the apparatus main body 1a. Therefore, the user is guided to lift the front surface side of the reversing unit 40 as indicated by the change from the state ST2 in FIG. 13A to the state ST3 in FIG. 13B. At this time, when the placement portion 12 receives an external force from the first inclined surface 60b, a large operation force is required for the user, and there is a concern that the operability decrease. That is, since the pressing down of the placement portion 12 by the first inclined surface 60b is pressing down against a spring force, when pulling out the reversing unit 40, there is a concern that the pressing down becomes a resistance and a large operation force is required for the user.

However, in the embodiment, since the first inclined surface 60b guides the placement portion 12 to the standby position after a part of the reversing unit 40 is lifted to climb over a part of the apparatus main body 1a, a large operation force is prevented from being required when detaching the reversing unit 40.

Note that, the operation force increases as the reversing unit 40 is pulled out, and is maximized immediately before the completion of the pressing down of the placement portion 12 by the first inclined surface 60b, that is, immediately before the placement portion 12 is displaced to the standby position. In other words, when the cam engagement portion 12dis positioned at a terminal end of the first inclined surface 60b, that is, a lower end portion of the cam portion 60a, the operation force is maximized.

Therefore, a timing at which a part of the reversing unit 40 is lifted to climb over a part of the apparatus main body 1a and a timing at which the operation force is maximized may not overlap. That is, the placement portion 12 may be pressed down by the first inclined surface 60bat the timing when a part of the reversing unit 40 is lifted to climb over a part of the apparatus main body 1a, and as described above, the timing when a part of the reversing unit 40 is lifted to climb over a part of the apparatus main body 1a and the timing when the operation force is maximized may not overlap.

In addition, in the embodiment, the locking member 47 is movable between the locking position at which the placement portion 12 is locked and the unlocking position at which the locking is released by being displaced in an intersecting direction intersecting the attachment and detachment direction of the reversing unit 40. The locking member 47 is pressed toward the locking position by the coil spring 48, which is an example of the pressing portion.

The cam member 60, which is a contact member engageable with the locking member 47, is provided at a position facing the locking member 47 when the reversing unit 40 is attached and detached. In the attached state of the reversing unit 40, the locking member 47 is positioned at the unlocking position by coming into contact with the cam member 60, and in the detached state of the reversing unit 40, the locking member 47 is positioned at the locking position by the pressing force of the coil spring 48.

According to such a configuration, the placement portion 12 can be locked and unlocked with a simple configuration.

In addition, the placement portion 12 is displaced to the standby position and the feeding position by swinging, and is pressed toward the feeding position. The apparatus main body 1aincludes the cam 13bthat presses down the placement portion 12 from the feeding position to the standby position. Then, in a state where the locking member 47 releases the locking, the cam 13b holds the placement portion 12 at the standby position (see FIG. 5A).

Accordingly, it is possible to prevent the placement portion 12 from moving to the feeding position in the attached state of the reversing unit 40, and thus it is possible to prevent the medium loaded on the placement portion 12 from dashing downstream in the feeding direction.

In addition, in the embodiment, the feeding path S along which the medium from the medium cassette 2 is fed is formed by attaching the reversing unit 40, and a part of the feeding path S is open by detaching the reversing unit 40. At this time, in addition to the feeding path S, the feeding path R and the third conveying path T3 are also open.

By detaching the reversing unit 40 in this manner, a plurality of paths can be open, and the jam processing operation becomes easier.

Further, the present disclosure is not limited to the embodiments and modifications described above and various modifications can be made within the scope of the disclosure set forth in the appended claims, and it is needless to say that these modifications also fall within the scope of the present disclosure.

What is claimed is:

1. A medium conveying apparatus comprising:
a placement portion on which a medium is to be placed in an inclined posture, the placement portion being displaceable between a feeding position at which the medium is fed and a standby position before starting the feeding of the medium;
a feeding portion configured to feed the medium from the placement portion in a feeding direction;
a conveying portion provided downstream of the feeding portion in the feeding direction and configured to convey the medium; and
a reversing unit provided to be attachable to and detachable from an apparatus main body and including, below the placement portion, a reversing portion that curves and reverses the medium, wherein
the placement portion is provided in the reversing unit, and
a region downstream of the placement portion in the feeding direction is exposed by detaching the reversing unit from the apparatus main body.

2. The medium conveying apparatus according to claim 1, wherein
the reversing unit includes a separation portion configured to separate the medium by nipping the medium between the separation portion and the feeding portion, and
the separation portion is separated from the feeding portion by detaching the reversing unit.

3. The medium conveying apparatus according to claim 1, wherein
the reversing unit includes a locking portion configured to lock the placement portion at the standby position, and
the locking portion releases the locking in an attached state of the reversing unit and locks the placement portion at the standby position in a detached state of the reversing unit.

4. The medium conveying apparatus according to claim 3, wherein
the apparatus main body includes a guide portion configured to guide the placement portion from the feeding position to the standby position when detaching the reversing unit from the attached state, and
when the reversing unit is detached, the locking portion locks, at the standby position, the placement portion guided from the feeding position to the standby position by the guide portion.

5. The medium conveying apparatus according to claim 4, wherein
the placement portion includes an engagement portion that engages with the guide portion,
the guide portion has an inclined surface with which the engagement portion comes into contact, and
when detaching the reversing unit, the placement portion is guided from the feeding position to the standby position by the inclined surface.

6. The medium conveying apparatus according to claim 5, wherein
the inclined surface is a first inclined surface,
the guide portion has a second inclined surface with which the engagement portion comes into contact, and
when attaching the reversing unit in a state where the placement portion is at the feeding position, the placement portion is guided from the feeding position to the standby position by the second inclined surface.

7. The medium conveying apparatus according to claim 4, wherein
a part of the reversing unit is configured to climb over a part of the apparatus main body when detaching the reversing unit, and
the guide portion guides the placement portion to the standby position after the reversing unit is lifted such that the part of the reversing unit climbs over the part of the apparatus main body.

8. The medium conveying apparatus according to claim 3, wherein
the locking portion is movable to a locking position at which the placement portion is locked and an unlocking position at which the locking is released by being displaced in an intersecting direction intersecting an attachment and detachment direction of the reversing unit,
a pressing portion configured to press the locking portion toward the locking position is provided,
a contact member configured to engage with the locking portion is provided at a position facing the locking portion when the reversing unit is attached and detached,
in the attached state of the reversing unit, the locking portion is positioned at the unlocking position by coming into contact with the contact member, and
in the detached state of the reversing unit, the locking portion is positioned at the locking position by the pressing portion.

9. The medium conveying apparatus according to claim 3, wherein
the placement portion is displaced to the standby position and the feeding position by swinging, and is pressed toward the feeding position,
the apparatus main body includes a cam that presses down the placement portion from the feeding position to the standby position, and
the cam holds the placement portion at the standby position in a state where the locking portion releases the locking.

10. The medium conveying apparatus according to claim 1, comprising:
a medium cassette provided vertically below the reversing unit and configured to accommodate the medium before being fed, wherein
the medium fed from the medium cassette is fed to the reversing portion,
a feeding path from the medium cassette to the reversing portion is formed by attaching the reversing unit, and
at least a part of the feeding path is open by detaching the reversing unit.

11. The medium conveying apparatus according to claim 7, comprising:
a medium cassette provided vertically below the reversing unit and configured to accommodate the medium before being fed, wherein
the medium fed from the medium cassette is fed to the reversing portion,
a feeding path from the medium cassette to the reversing portion is formed by attaching the reversing unit,
at least a part of the feeding path is open by detaching the reversing unit,
the reversing unit includes a first path forming portion where the feeding path is formed,
the apparatus main body includes a second path forming portion where the feeding path is formed,
in the attached state of the reversing unit, the first path forming portion and the second path forming portion overlap each other when viewed from a width direction intersecting the feeding direction of the medium,
a wall portion is provided in a direction of detaching the reversing unit with respect to the first path forming portion, and
when detaching the reversing unit, the first path forming portion, which is a part of the reversing unit, climbs over the wall portion, which is a part of the apparatus main body.

12. A recording apparatus comprising:
the medium conveying apparatus according to claim 1; and
a recording unit configured to perform recording on the medium conveyed by the medium conveying apparatus.
